(19) United States
(12) Patent Application Publication
(10) Pub. No.: US 2008/0134068 A1
(43) Pub. Date: Jun. 5, 2008

(54) ACCESSORIES AND CLOTHES FOR UI ELEMENTS

(76) Inventor: Erika Reponen, Tampere (FI)

Correspondence Address: PERMAN & GREEN, 425 POST ROAD, FAIRFIELD, CT, 06824, US

(21) Appl. No.: 11/567,031

(22) Filed: Dec. 5, 2006

(51) Int. Cl. G06F 3/048

(52) U.S. Cl. 715/765

(57) ABSTRACT

A method for a user interface is disclosed. The method comprises providing a plurality of items in a display view; retrieving a fashion indicator; and providing a visual effect. A user interface, an apparatus, a computer program, and a system for implementing the method is also disclosed.

### TECHNICAL FIELD

The disclosed embodiment relates to a method for a user interface, a user interface, an apparatus, a computer program, and a system.

### BACKGROUND OF THE INVENTION

Portable electronic devices becomes more and more a gadget for expressing oneself in a social environment. This puts higher demands on making the apparatus user-configurable. US 2006/0062168 A1 discloses a mobile communication terminal with enhanced menu effects using a menu effect layer for allowing increased visibility of selected menu items. However, there is still a need for personalizing portable electronic devices.

### SUMMARY OF THE INVENTION

In view of the above, an objective of the invention is to solve or at least reduce the problems discussed above. In particular, an objective is to provide a personalised user interface in an improved manner.

According to a first aspect of the disclosed embodiment, there is provided a method for a user interface, comprising
providing a plurality of items on in a display view;
determining a theme comprising a fashion indicator; and
providing a visual effect associated with said fashion indicator in said display view.

The items provided in the display view may be basic items, and the method may comprise retrieving an additional item comprising said fashion indicator, wherein said visual effect is said additional item fitted to at least one of said basic items in said display view.

Thus, a personalized user interface is provided by the method, where basic items can be personalized with additional items.

The providing of said visual effect may comprise providing one or more effect layers among said basic items. Thus, fitting the additional item to the basic items is improved.

The providing of said visual effect may comprise making said visual effect appear according to a predetermined appearing rule. The appearing rule may comprise taking account to any of a group comprising: a measured temperature, a date, a time, a user interaction, an incoming message, an incoming advertisement, a rendered media item, a position, connection to additional device, communication with certain entity, and an incoming phone call. Thus, the additional items can be made to show up on particular occasions.

The basic items may be any mix from the user interface component group comprising an icon, a list item, an avatar, a virtual puppet, a menu item, a file item, a symbol, a help function item, a scroll bar, a selection bar, a selection frame, and a status message item.

The retrieving may comprise accessing a fashion indicator boutique. The fashion indicator boutique may be a web store. The accessing of said fashion indicator boutique may further comprise buying the fashion indicator, or buying fashion goods associated with the fashion indicator. The accessing of said fashion indicator boutique may further comprise getting said additional item as an advertisement from a fashion boutique. The method may comprise creating or editing said fashion indicator. The creating or editing said fashion indicator may comprise setting parameters for said visual effects. The method may further comprise transmitting said fashion indicator to another peer entity. The retrieving may further comprise receiving said fashion indicator from another peer entity. These features provides for different ways the additional items can be retrieved, and thus the different contexts in which the additional items can be used for entertainment, advertising, commersialisation, communication, etc.

The additional item may illustrate any of a group comprising: an article of clothing, accessories, jewellery, footwear, headgear, items of equipment, and sports goods. The fashion indicator may be a visual fragrance. These examples are suited for “dressing-up” the basic items of the user interface.

The method may further comprise enabling a user to re-fit the additional item on said basic item, or on another basic item.

According to the disclosed embodiment, it is for example enabled to change to new additional item on a basic item, replace the additional item, and/or rearrange the additional item on the basic item. Changing to new additional item may be provided by presenting a plurality of alternative additional items to a user upon user interaction, wherein selection of an alternative additional item is enabled. Replacing the additional item may be provided by enabling a user to make individual items by selecting one or more additional items through a graphical user interface by browsing, clicking, marking, or navigating among potential additional items for replacement. As the additional item for replacement is selected, the user may access an archive, locally or remotely, to acquire the additional item, which is similar to the procedure for changing to a new additional item. Rearranging the additional item may comprise selecting the additional item to be rearranged in a similar way of selecting as has been demonstrated above, and then change size, location, and/or shape of the selected additional item. Thus, the additional item may be dynamically adjusted to the basic item upon user interaction, e.g. by changing size, location, and/or shape to fit to another basic item to which the user moves the additional item.

According to the disclosed embodiment, it is for example enabled to change to new additional item on a basic item, replace the additional item, and/or rearrange the additional item on the basic item. Changing to new additional item may be provided by presenting a plurality of alternative additional items to a user upon user interaction, wherein selection of an alternative additional item is enabled. Replacing the additional item may be provided by enabling a user to make individual items by selecting one or more additional items through a graphical user interface by browsing, clicking, marking, or navigating among potential additional items for replacement. As the additional item for replacement is selected, the user may access an archive, locally or remotely, to acquire the additional item, which is similar to the procedure for changing to a new additional item. Rearranging the additional item may comprise selecting the additional item to be rearranged in a similar way of selecting as has been demonstrated above, and then change size, location, and/or shape of the selected additional item. Thus, the additional item may be dynamically adjusted to the basic item upon user interaction, e.g. by changing size, location, and/or shape to fit to another basic item to which the user moves the additional item.

In the user interface according to the disclosed embodiment, when a basic item is browsed, clicked, marked, or navigated to, there may be an option item presented in the user interface enabling a user to to change to new additional item on the basic item, replace the additional item, and/or rearrange the additional item on the basic item.

According to a second aspect of the disclosed embodiment, there is provided a user interface comprising a display arranged to display a display view with a plurality of displayed items; and a theme handler arranged to arrange said display view according to a theme comprising a fashion indicator, wherein the arrangement of said display view comprises provision of a visual effect illustrating said fashion indicator.

The items may be basic items, and the user interface may further comprise an accessing means arranged to retrieve an additional item, wherein said additional item comprises said fashion indicator, wherein said user interface is arranged to provide said visual effect comprising said additional item fitted to at least one of said basic items in said display view.

The user interface may further comprise an theme handler for providing said visual effect as one or more effect layers among said basic items. The theme handler may be provided by processing means.

The visual effect may be arranged to appear according to a predetermined appearing rule. The appearing rule may take account to any of a group comprising: a measured temperature, a date, a time, a user interaction, an incoming message, an incoming advertisement, a rendered media item, a position, connection to additional device, communication with certain entity, and an incoming phone call.

The basic items of the user interface may be any mix from the user interface component group comprising an icon, a list item, an avatar, a virtual puppet, a menu item, a file item, a symbol, a help function item, a scroll bar, a selection bar, a selection frame, and a status message item.

The accessing means may be arranged to retrieve said additional items from a fashion indicator boutique. The accessing means may comprise transaction means for securely accessing a web store of said fashion indicator boutique. The transaction means may enable buying said additional item. The accessing means may be arranged to retrieve said additional item as an advertisement from said fashion indicator boutique. The user interface may further comprise input means arranged to receive user input; and an editor arranged to generate said fashion indicator upon and based on said user input. The user input may comprise parameters for said visual effects. The user interface may be arranged to enable a user to transmit said fashion indicator to another peer entity. The accessing means may be arranged to retrieve said additional item by receiving said theme from another peer entity.

The additional item may illustrate any of a group comprising: an article of clothing, accessories, jewellery, footwear, headgear, items of equipment, and sports goods. The fashion indicator may be a visual fragrance.

According to a third aspect of the disclosed embodiment, there is provided an apparatus comprising a display arranged to display a display view with a plurality of displayed items; and

a theme handler arranged to arrange said display view according to a theme comprising a fashion indicator, wherein the arrangement of said display view comprises provision of a visual effect illustrating said fashion indicator.

The items may be basic items, and the apparatus may further comprise an accessing means arranged to retrieve an additional item, wherein said additional item comprises said fashion indicator, and said theme handler comprises a processor for controlling said display and accessing means, wherein said processor is arranged to provide control such that a visual effect comprising said additional item is fitted to at least one of said basic items in said display view.

The processor may be arranged to provide said visual effect as one or more effect layers among said basic items. The processor may be arranged to provide said visual effect according to a predetermined appearing rule. The appearing rule may take account to any of a group comprising: a measured temperature, a date, a time, a user interaction, an incoming message, an incoming advertisement, a rendered media item, a position, connection to additional device, communication with certain entity, and an incoming phone call.

The basic item may be any of the group comprising an icon, a list item, an avatar, a virtual puppet, a menu item, a file item, a symbol, a help function item, a scroll bar, a selection bar, a selection frame, and a status message item.

The accessing means may be arranged to retrieve said additional items from a fashion indicator boutique. The accessing means may comprise transaction means for securely accessing a web store of said fashion indicator boutique. The transaction means may enable buying said additional item. The accessing means may be arranged to retrieve said additional item as an advertisement from said fashion indicator boutique. The apparatus may further comprise input means arranged to receive user input; and an editor arranged to generate said fashion indicator upon and based on said user input. The user input may comprise parameters for said visual effects. The apparatus may further comprise a transmitter for transmitting said fashion indicator to another peer entity. The accessing means may be arranged to retrieve said additional item by receiving said additional item from another peer entity.

The additional item may illustrate any of a group comprising: an article of clothing, accessories, jewellery, footwear, headgear, items of equipment, and sports goods. The fashion indicator may be a visual fragrance.

The apparatus may be a mobile communication apparatus, a portable digital assistant, a portable media player, a digital camera, or a cell phone.

According to a fourth aspect of the disclosed embodiment, there is provided a computer-readable medium having computer-executable components comprising instructions for providing a plurality of items on in a display view;

determining a theme comprising a fashion indicator; and
providing a visual effect associated with said fashion indicator in said display view.

The computer-readable medium may have computer-executable components comprising instructions for retrieving an additional item comprising said fashion indicator; and providing a visual effect wherein said additional item is fitted to at least one of said basic items in said display view.

The computer-readable medium may further comprise instructions for providing one or more effect layers among said items when providing said visual effect.

The computer-readable medium may further comprise instructions for making said visual effect appear according to a predetermined appearing rule. The computer-readable medium may further comprise instructions for applying said appearing rule upon an interrupt signal depending on a value of any of a group comprising: a measured temperature, a date, a time, a user interaction, an incoming message, an incoming advertisement, a rendered media item, a position, connection to additional device, communication with certain entity, and an incoming phone call.

According to a fifth aspect of the disclosed embodiment, there is provided a system comprising an apparatus comprising a display arranged to display a display view with a plurality of displayed items; a theme receiver for receiving a theme comprising a fashion indicator; and a theme handler arranged to arrange said display view according to said theme, wherein the arrangement of said display view comprises provision of a visual effect illustrating said fashion indicator; and

a fashion indicator server arranged to provide a theme comprising a fashion indicator,
wherein said apparatus is arranged to receive said theme from said fashion indicator server.

The items may be basic items, and the apparatus may further comprise an accessing means arranged to retrieve an additional item, wherein said additional item comprises a fashion indicator; and a processor for controlling said display and accessing means, wherein said theme handler is arranged to provide control such that said visual effect comprising said additional item fitted to at least one of said basic items in said display view.

The apparatus may be arranged to buy said fashion indicator to receive said fashion indicator from said fashion indicator server. The fashion indicator, or the right to access the fashion indicator may be included when buying an associated fashion goods.

The fashion indicator server may be arranged to provide said additional item as an advertisement to said apparatus.

The system may be a mobile communication system, and said apparatus may be a mobile communication apparatus.

The features of the second to the fifth aspects of the invention provides similar effects and advantages as those demonstrated for the first aspect of the disclosed embodiment.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the disclosed embodiment will appear from the following detailed disclosure, from the attached dependent claims, as well as from the drawings.

### BRIEF DESCRIPTION OF THE DRAWINGS

The above, as well as additional objects, features and advantages of the disclosed embodiment, will be better understood through the following illustrative and non-limiting detailed description of preferred embodiments of the disclosed embodiment, with reference to the appended drawings, where the same reference numerals will be used for similar elements, wherein:

FIG. 1 is a flow chart illustrating a method for a user interface according to an embodiment of the disclosed embodiment;

FIG. 2 is a flow chart illustrating provision of the visual effect according to an embodiment of the disclosed embodiment;

FIG. 3 schematically illustrates functionalities of a user interface according to an embodiment of the disclosed embodiment;

FIG. 4 scematically shows an apparatus according to an embodiment of the disclosed embodiment;

FIG. 5 illustrates a system architecture for managing a system according to an embodiment of the disclosed embodiment;

FIG. 6 is an exemplary display view;

FIG. 7 illustrates a further example of a display view;

FIG. 8 is a flow chart illustrating a method for a user interface according to an embodiment of the disclosed embodiment;

FIG. 9 is a flow chart illustrating provision of the visual effect according to an embodiment of the disclosed embodiment;

FIG. 10 schematically illustrates functionalities of a user interface according to an embodiment of the disclosed embodiment;

FIG. 11 schematically shows an apparatus according to an embodiment of the disclosed embodiment;

FIG. 12 is another exemplary display view; and

FIG. 13 is a further exemplary display view.

### DETAILED DESCRIPTION OF PREFERRED EMBODIMENTS

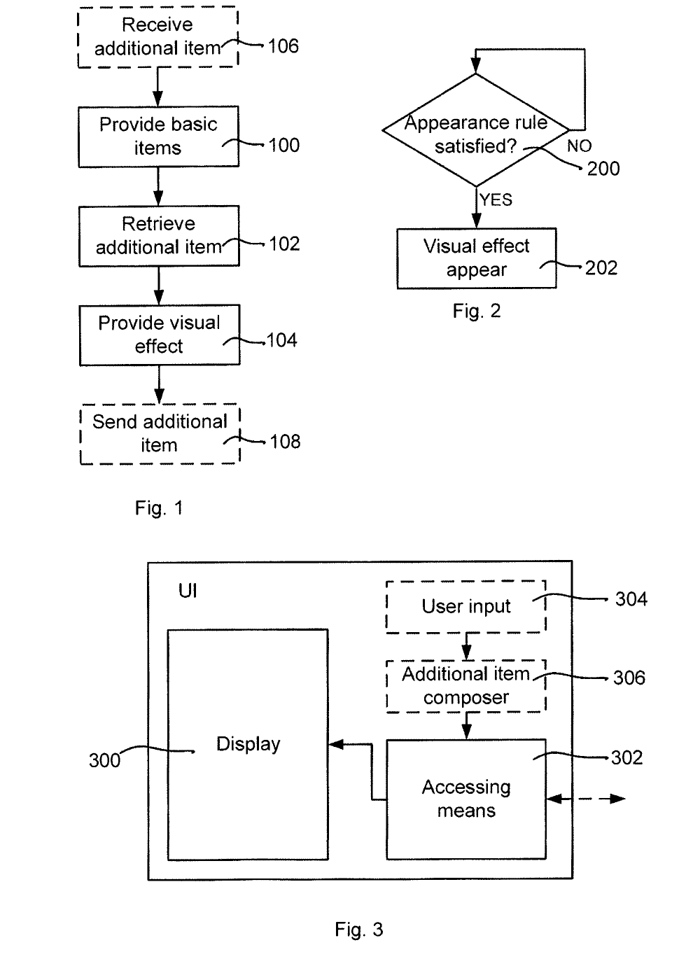

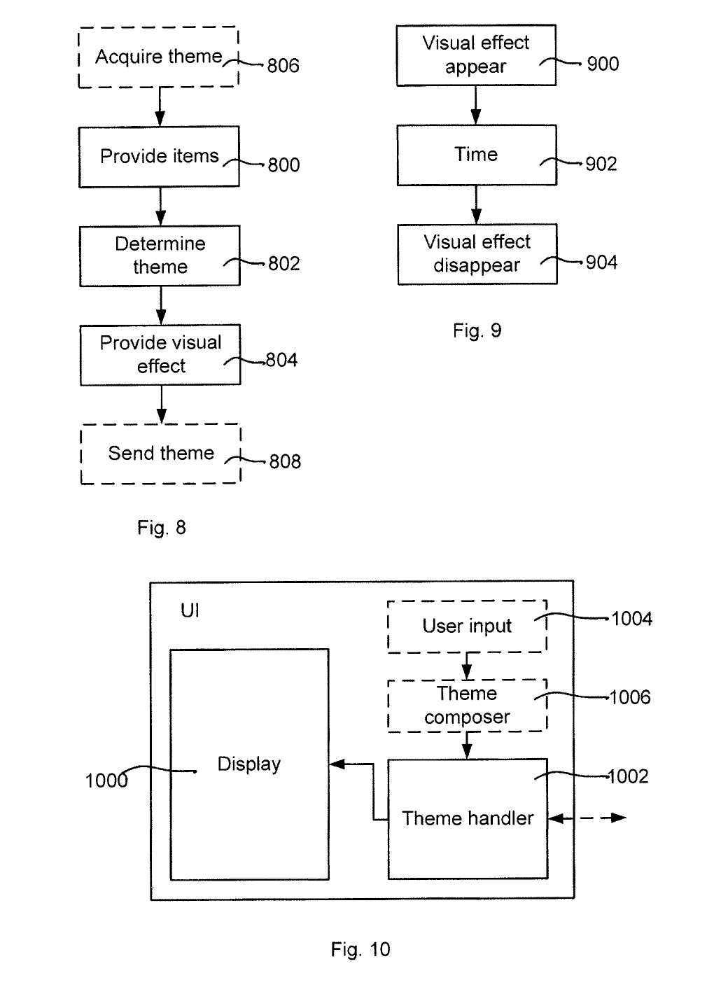

FIG. 1 is a flow chart illustrating a method for a user interface. Items, such as icons, short cuts, list items, etc., are provided 100 in a display view, as will be exemplified with reference to FIG. 6. An additional item is retrieved 102. Themes are here considered as a recurring contribution to the display view, which contribution is recurring although the display view is changed, e.g. during browsing a menu. Item provision 100 and retrieval 102 of additional item can be performed in any order, or in parallel. Then, a visual effect is provided 104 in said display view. The visual effect can be an illustration of an article of clothing, accessories, jewellery, footwear, headgear, items of equipment, or sports goods, as will be examplified with reference to FIGS. 7 and 8.

Optionally, the additional item is received 106, if not already present, to be able to determine parameters about the visual effects. The parameters can define images, add-ons to existing images, image effects, etc. The reception 106 can be performed by buying the additional item from a provider or additional items, such as a fashion boutique, which can be a web store providing additional items comprising fashion indicators. Alternatively, the additional item can be received upon buying e.g. an article of clothing, e.g. as a special offer, or be acquired as a commercial advertisement for the article of clothing. The additional item can also be received from another peer entity, e.g. in a message. The additional item can also be composed by a user.

Optionally, the additional item can be sent 108 to a recipient, e.g. as an add-on feature to a message.

FIG. 2 is a flow chart illustrating provision of the visual effect according to an embodiment of the disclosed embodiment. First, a rule for viewing the visual effect is to be satisfied 200, e.g. a certain date, time, temperature, position, connection to additional device, communication with certain entity, etc., and then the visual effect appear 202 on the display view. Optionally, it is displayed for a predetermined time, and then, optionally, it disappears from the display view, or remains until a user decides to remove the effect by user interaction. All this can be controlled by the parameters for the additional item, which can comprise rules for when or how the effect will appear in the display view, for how long time it is to be shown, and how the visual effect is to disappear, if it should, from the display view. The appearing 202 can be in form of an animation, e.g. the basic items are getting dressed by the additional items, and the visual effect can disappear in form of an animation, e.g. the basic items are undressed.

FIG. 3 schematically illustrates a user interface UI comprising a display 300 and an accessing means 302. The display 300 is arranged to display a display view. The accessing means 302 is arranged retrieve additional items such that the user interface UI can provide additional visual effects where the display view comprises basic items together with the additional items. The effects can be provided in one or more separate effect layers, which is provided over/under the basic items presented in the display view, i.e. in the background and the foreground, whichever is appropriate for the additional items, of the basic items. Here, the term ‘layer’ should be construed broadly when considering a three-dimensional user interface, where the effect layers also can be three-dimensional.

The user interface UI can further comprise input means 304, such as a key pad, a touch screen, a rotatable dial, one or more navigation and soft keys, application specific keys, etc., arranged to enable a user to provide a user input. An optional composer 306 for additional items can be provided with user inputs from the input means 304 to enable a user to create an additional item upon interaction with the user interface UI.

The user interface UI can be arranged to enable transmission of an additional item to another peer entity (not shown). The peer entity can comprise a similar apparatus as the one holding the user interface UI. An example is two mobile phones, wherein one of them sends an additional item to the other.

The method can further comprise enabling a user to re-fit the additional item on said basic item, or on another basic item.

According to the disclosed embodiment, it is for example enabled to change to new additional item on a basic item, replace the additional item, and/or rearrange the additional item on the basic item. Changing to new additional item can be provided by presenting a plurality of alternative additional items to a user upon user interaction, wherein selection of an alternative additional item is enabled. Replacing the additional item can be provided by enabling a user to make individual items by selecting one or more additional items through a graphical user interface of the user interface UI by browsing, clicking, marking, or navigating among potential additional items for replacement. As the additional item for replacement is selected, the user may access an archive, locally or remotely, to acquire the additional item, which is similar to the procedure for changing to a new additional item. Rearranging the additional item can comprise selecting the additional item to be rearranged in a similar way of selecting as has been demonstrated above, and then change size, location, and/or shape of the selected additional item. Thus, the additional item can be dynamically adjusted to the basic item upon user interaction, e.g. by changing size, location, and/or shape to fit to another basic item to which the user moves the additional item.

In the user interface UI, when a basic item is browsed, clicked, marked, or navigated to, there can be an option item presented in the user interface enabling a user to change to new additional item on the basic item, replace the additional item, and/or rearrange the additional item on the basic item.

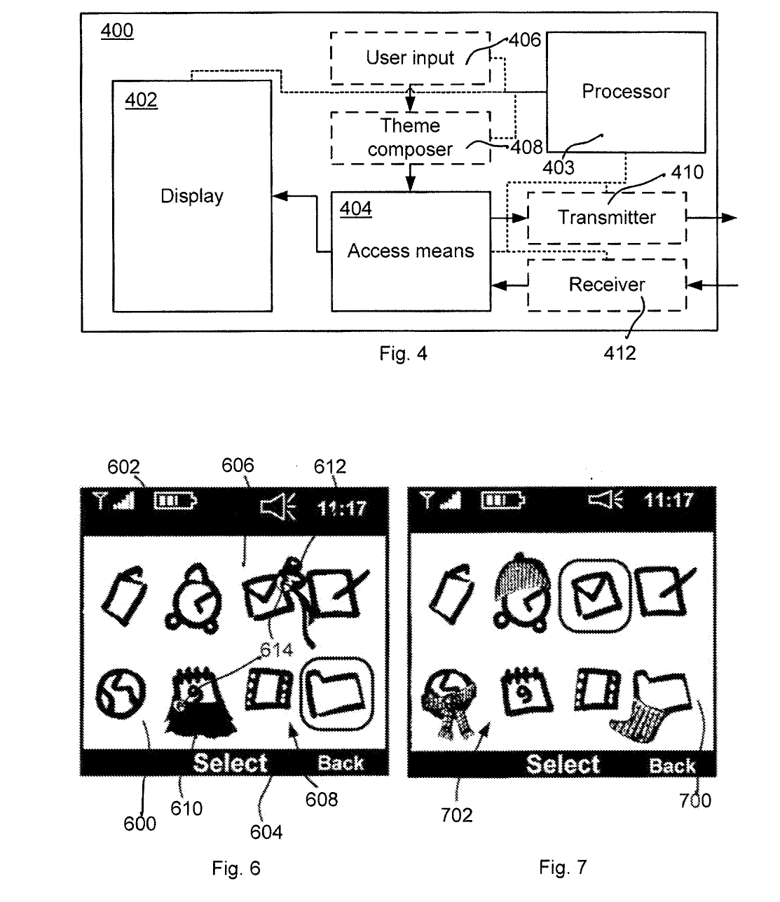

FIG. 4 shows an apparatus 400 according to an embodiment of the disclosed embodiment. The apparatus 400 can comprise a user interface similar to the one described with reference to FIG. 3.

The apparatus 400 comprises a display 402, a processor 403, and an accessing means 404, and optionally a user input 406, a theme composer 408, a transmitter 410, and a receiver 412.

The display 402 is arranged to display a display view with one or more basic items, such as normally occurring UI components as icons, scroll bars, list items, etc. The accessing means 404 is arranged to retrieve additional visual effects to the display view, i.e. additional items comprising fashion indicators. The effects can be provided in one or more separate effect layers, which is provided over/under items presented in the display view, i.e. in the background and/or the foreground of the basic items, or the effects can be three-dimensional, i.e. present in any plane with regard to the basic items. The processor 403 controls the display 402 and the accessing means 404 to provide the visual effects such that the additional item is fitted to at least one of the basic items in the display view. The processor 403 preferably achieves this by executing a computer program, which will be further discussed below. The processor optionally controls the user input 406, the item composer 408, the transmitter 410, and the receiver 412.

The user input 406 can optionally be used for editing or creating a user configured additional item by the composer 408 for additional items. The additional item can optionally be received by the receiver 412. The additional item can optionally also be transmitted by the transmitter 410 to another apparatus, such as directly to a peer entity, to a communication system component, or via a communication system component to a peer entity.

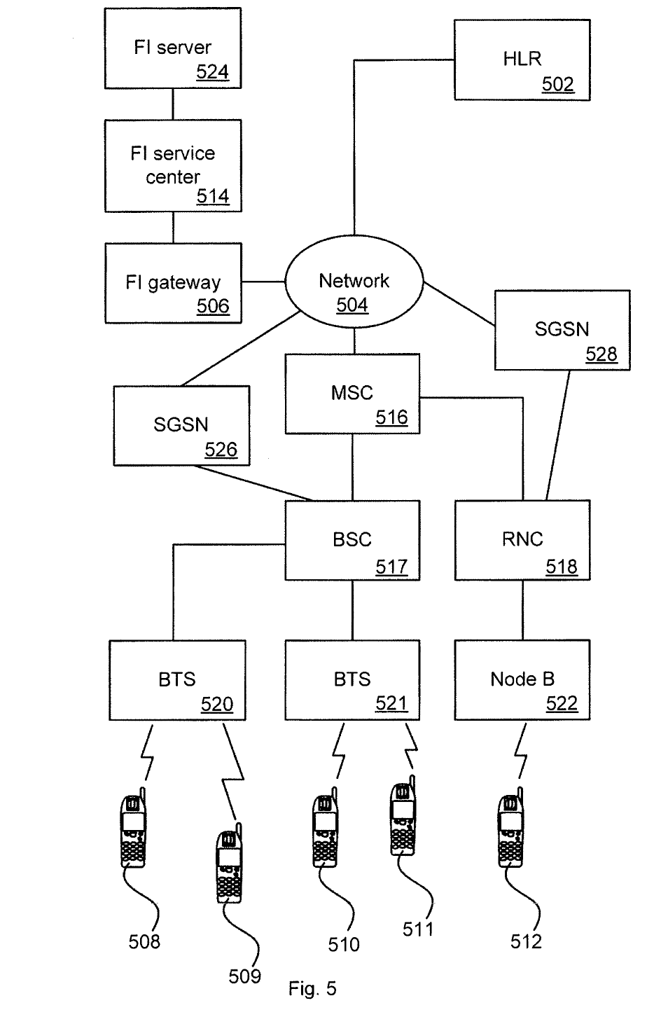

A system architecture for managing a system 500 according to an embodiment of the disclosed embodiment is shown in FIG. 5. A Home Location Register (HLR) 502 contains a database (not shown) including relevant subscriber information for provision of telecommunication service. A CCITT specified network 504 interconnects the individual parts of the system 500. A fashion indicator (FI) gateway 506 is a switching unit routing a message or a call to a mobile communication apparatus 508-512. The additional item comprising a fashion indicator can be an illustration of an article of clothing, accessories, jewellery, footwear, headgear, items of equipment, or sports goods. It can also be a visual fragrance. An FI Service Center 514 (FISC) and the VF gateway 506 handles and routes the FI's between the FISC 514 and the network 504. From the network 504, the FI messages are routed to the mobile communication apparatuses 508-512 via a Mobile Switching Center (MSC) 516 to a Base Station Controller (BSC) 517 and a Base Transceiver Station (BTS) 520, 521, or a Radio Network Controller (RNC) 518 and a Node B 522. Alternatively, the FI messages are routed to the mobile communication apparatuses 508-512 via a Serving GPRS Support Node (SGSN) 526, 528 to the BSC 517 and the BTS 520, 521, or the RNC 518 and the Node B 522, respectively. The BTS 520, 521 or the Node B 522 establish the air connection to the mobile communication apparatuses 508-512.

According to an embodiment of the disclosed embodiment, a network operator or other third party company handling a fashion indicator server 524 could offer a fashion indicator sharing function between persons not knowing each other. For example a network operator may have a fashion indicator server 524 supporting a feature where the user may send a fashion indicator request from his mobile communication apparatus 508-512 to the fashion indicator server 524 by using a special phone number. This fashion indicator server 524 automatically places people sending a similar request message to the fashion indicator server 524 into “fashion indicator groups”, “parfumeries”, or “fitting cubicles”. Whenever a user, being part of such a group, sends a message to the fashion indicator server 524, the fashion indicator server 524 adds the fashion indicator message ‘on top’ of the previous communication in the group and forwards the up-dated information in an VF message to all the other persons in the group. The fashion indicator server 524 is responsible for the distribution of the VF messages and the distribution lists. The system can also be used for advertising brands, sports gear, night club memberships, sport teams, stars, etc. by providing fashion indicators. The fashion indicator can for example be illustration of a garment, where adverts or offers on additional items for use in a user interface and/or corresponding garment are provided, e.g. by push messages. A scenario can be the system detecting a user and its apparatus being in a certain position, which is associated to e.g. a boutique. Then, the system can communicate an alert to the apparatus, wherein the alert indicates to the user that a fashion indicator is available at the nearby boutique. Upon receiving the fashion indicator, the user may also see a piece of fashion goods in the boutique associated with the fashion indicator. Thus, a favourable way of advertising is provided by first promoting the fashion indicator, and then promoting the associated fashion goods.

FIG. 6 is an exemplary display view 600 for illustrating provided effects of the disclosed embodiment. On top 602 of the display view, status data, such as signal strength, battery status, active options, time of day, etc. can be displayed. At the base 604 of the display view, options associated with soft keys can be displayed. However, this is just illustrative examples not being vital for the disclosed embodiment, but illustrated for giving an exemplary environment for the invention. In an area 606 for presenting information to a user, one or more basic items 608 are displayed. In the present example, a menu header, and eight menu items are presented. One of the menu items is surrounded by a marking indicating a navigation position, which can be controlled by input means of the user interface. The display view 600 further comprises a visual effect layer illustrating a additional items 610, 612 in form of a skirt 610 fitted on one of the basic items, and a bow 612 on another one of the basic items. In this example, both the additional fashion indicators hold a brand indicator 614, which for example is suitable in the case of promoting the brand by advertising, or for indicating that even the items, here the icons, are wearing clothes with a fashionable brand.

FIG. 7 illustrates a further example of a display view 700 having similar display items as illustrated in FIG. 6, but with a visual effect layer illustrating the basic items dressed in knitwear 702.

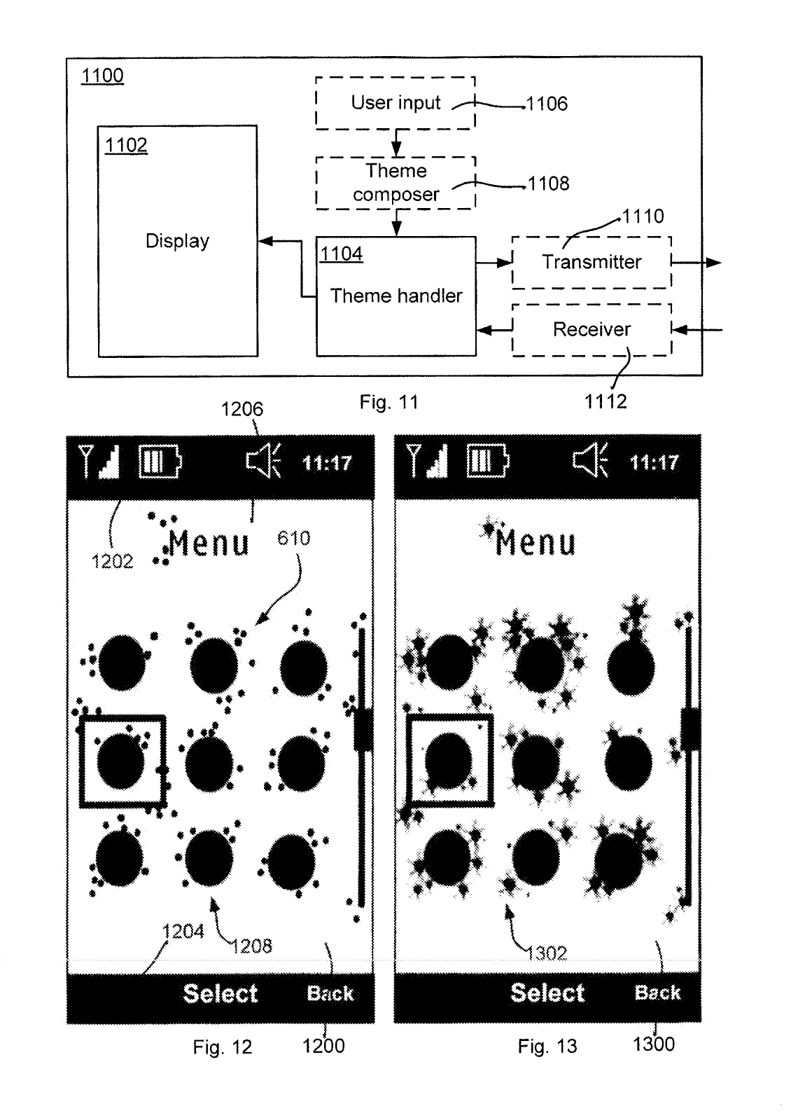

FIG. 8 is a flow chart illustrating a method for a user interface according to an embodiment of the disclosed embodiment. Items, such as icons, short cuts, list items, etc., are provided 800 in a display view, as are exemplified with reference to any of FIGS. 6, 7, 12 or 13. A theme is also determined 802. Themes are here considered as a recurring contribution to the display view, which contribution is recurring although the display view is changed, e.g. during browsing a menu. Item provision 800 and theme determination 802 can be performed in any order, or in parallel. Then, a visual effect is provided 804 in said display view. The visual effect can be an illustration of a fragrance, as will be exemplified with reference to FIGS. 12 and 13.

Optionally, the theme is acquired 806, if not already present, to be able to determine parameters from the theme on the visual effects. The parameters can define images, add-ons to existing images, image effects, etc. The acquireing can be performed by buying the theme from d theme provider. Alternatively, the theme can be acquired upon buying a perfume, e.g. as a special offer, or be acquired as a commercial advertisement for a perfume. The theme can also be received from another peer entity, e.g. in a message. The theme can also be composed by a user.

Optionally, the theme can be sent 808 to a recipient, e.g. as an add-on feature to a message. This provides for sending a message that is an electronic equivalent to a scented letter.

FIG. 9 is a flow chart illustrating provision of the visual effect according to an embodiment of the disclosed embodiment. First, the visual effect appear 900 on the display view, then it is displayed 902 for a predetermined time, and then, optionally, it disappears 904 from the display view. This can be controlled by the parameters for the theme, which can comprise rules for the effect on how the effect will appear in the display view, for how long time it is to be shown, and how the visual effect is to disappear, if it should, from the display view. The appearing 900 can be in form of a spraying, painting, drawing, fuming, exploding, burning, raining, snowing, growing, etc. effect, where e.g. an image representing a perfume package grows out of the background, and drops representing the perfume is applied with a spraying effect as drops on items in the display view, and the visual effect disappears after a while by the perfume package melts down into the background and the drops vapourises.

FIG. 10 schematically illustrates a user interface UI comprising a display 1000 and a theme handler 1002. The display 1000 is arranged to display a display view. The theme handler 1002 is arranged to provide additional visual effects to the display view according to a theme. The effects can be provided in a separate effect layer, which is provided over items presented in the display view, or in the background of the items. Here, the term ‘layer’ should be construed broadly when considering a three-dimensional user interface, where the effect layer also can be three-dimensional. The theme handler 302 can optionally be arranged to acquire a theme, from which the theme handler 1002 determines parameters on the visual effects.

The user interface UI can further comprise input means 1004, such as a key pad, a touch screen, a rotatable dial, one or more navigation and soft keys, application specific keys, etc., arranged to enable a user to provide a user input. An optional theme composer 1006 can be provided with user inputs from the input means 1004 to enable a user to create a theme upon interaction with the user interface UI.

The user interface can be arranged to enable transmission of a theme to another peer entity (not shown). The peer entity can comprise a similar apparatus as the one holding the user interface UI.

FIG. 11 shows an apparatus 1100 according to an embodiment of the disclosed embodiment. The apparatus 1100 can comprise a user interface similar to the one described with reference to FIG. 3 or 10.

The apparatus 1100 comprises a display 1102, a theme handler 1104, and a user input 1106, and optionally a theme composer 1108, a transmitter 1110, and a receiver 1112.

The display 1102 is arranged to display a display view with one or more items, such as normally occurring UI components as icons, scroll bars, list items, etc. The theme handler 1104 is arranged to provide additional visual effects to the display view according to a theme. The effects can be provided in a separate effect layer, which is provided over items presented in the display view, or in the background of the items, or the effects can be three-dimensional, i.e. present in any plane with regard to the items. The user input 1106 can optionally be used for acquireing a user configured theme by the theme composer 1108. The theme can optionally be received by the receiver 1112. The theme can optionally also be transmitted by the transmitter 1110 to another apparatus, such as directly to a peer entity, to a communication system component, or via a communication system component to a peer entity.

The invention has mainly been described above with reference to a few embodiments. However, as is readily appreciated by a person skilled in the art, other embodiments than the ones disclosed above are equally possible within the scope of the invention, as defined by the appended patent claims.

1. A method for a user interface, comprising
providing a plurality of items on in a display view;
determining a theme comprising a fashion indicator; and
providing a visual effect associated with said fashion indicator in said display view.

2. The method according to claim 1, wherein said items provided in the display view are basic items, the method comprising
retrieving an additional item comprising said fashion indicator, wherein
said visual effect is said additional item fitted to at least one of said basic items in said display view.

3. The method according to claim 2, wherein said providing of said visual effect comprises providing one or more effect layers among said basic items.

4. The method according to claim 1, wherein said providing of said visual effect comprises making said visual effect appear according to a predetermined appearing rule.

5. The method according to claim 4, wherein said appearing rule comprises taking account to any of a group comprising: a measured temperature, a date, a time, a user interaction, an incoming message, an incoming advertisement, a rendered media item, a position, connection to additional device, communication with certain entity, and an incoming phone call.

6. The method according to claim 2, wherein said basic items are any mix from the user interface component group comprising an icon, a list item, an avatar, a virtual puppet, a menu item, a file item, a symbol, a help function item, a scroll bar, a selection bar, a selection frame, and a status message item.

7. The method according to claim 2, wherein said retrieving comprises accessing a fashion indicator boutique.

8. The method according to claim 7, wherein said fashion indicator boutique is a web store.

9. The method according to claim 7, wherein accessing said fashion indicator boutique further comprises buying the fashion indicator.

10. The method according to claim 7, wherein accessing said fashion indicator boutique further comprises getting said additional item as an advertisement from a fashion boutique.

11. The method according to claim 1, further comprising creating or editing said fashion indicator.

12. The method according to claim 11, wherein creating or editing said fashion indicator comprises setting parameters for said visual effects.

13. The method according to claim 11, further comprising transmitting said fashion indicator to another peer entity.

14. The method according to claim 2, wherein said retrieving further comprises receiving said fashion indicator from another peer entity.

15. The method according to claim 2, wherein said additional item illustrates any of a group comprising: an article of clothing, accessories, jewellery, footwear, headgear, items of equipment, and sports goods.

16. The method according to claim 1, wherein said fashion indicator is a visual fragrance.

17. A user interface comprising
a display arranged to display a display view with a plurality of displayed items; and
a theme handler arranged to arrange said display view according to a theme comprising a fashion indicator, wherein the arrangement of said display view comprises provision of a visual effect illustrating said fashion indicator.

18. The user interface according to claim 17, wherein said items are basic items, the user interface further comprising an accessing means arranged to retrieve an additional item, wherein said additional item comprises said fashion indicator, wherein said user interface is arranged to provide said visual effect comprising said additional item fitted to at least one of said basic items in said display view.

19. The user interface according to claim 17, wherein said theme handler is arranged to provide said visual effect as one or more effect layers among basic items.

20. The user interface according to claim 17, wherein said visual effect is arranged to appear according to a predetermined appearing rule.

21. The user interface according to claim 20, wherein said appearing rule takes account to any of a group comprising: a measured temperature, a date, a time, a user interaction, an incoming message, an incoming advertisement, a rendered media item, a position, connection to additional device, communication with certain entity, and an incoming phone call.

22. The user interface according to claim 18, wherein said basic items are any mix from the user interface component group comprising an icon, a list item, an avatar, a virtual puppet, a menu item, a file item, a symbol, a help function item, a scroll bar, a selection bar, a selection frame, and a status message item.

23. The user interface according to claim 18, wherein said accessing means is arranged to retrieve said additional items from a fashion indicator boutique.

24. The user interface according to claim 23, wherein said accessing means comprises transaction means for securely accessing a web store of said fashion indicator boutique.

25. The user interface according to claim 24, wherein said transaction means enable buying said additional item.

26. The user interface according to claim 23, wherein said accessing means is arranged to retrieve said additional item as an advertisement from said fashion indicator boutique.

27. The user interface according to claim 17, further comprising
input means arranged to receive user input; and
an editor arranged to generate said fashion indicator upon and based on said user input.

28. The user interface according to claim 27, wherein said user input comprises parameters for said visual effects.

29. The user interface according to claim 17, arranged to enable a user to transmit said fashion indicator to another peer entity.

30. The user interface according to claim 18, wherein said accessing means is arranged to retrieve said additional item by receiving said theme from another peer entity.

31. The user interface according to claim 18, wherein said additional item illustrates any of a group comprising: an article of clothing, accessories, jewellery, footwear, headgear, items of equipment, and sports goods.

32. The user interface according to claim 17, wherein said fashion indicator is a visual fragrance.

33. An apparatus comprising
a display arranged to display a display view with a plurality of displayed items; and
a theme handler arranged to arrange said display view according to a theme comprising a fashion indicator, wherein the arrangement of said display view comprises provision of a visual effect illustrating said fashion indicator.

34. The apparatus according to claim 33, wherein said items are basic items, the apparatus further comprises an accessing means arranged to retrieve an additional item, wherein said additional item comprises said fashion indicator, and said theme handler comprises a processor for controlling said display and accessing means, wherein said processor is arranged to provide control such that a visual effect comprising said additional item is fitted to at least one of said basic items in said display view.

35. The apparatus according to claim 34, wherein said processor is arranged to provide said visual effect as one or more effect layers among said basic items.

36. The apparatus according to claim 33, wherein said theme handler is arranged to provide said visual effect according to a predetermined appearing rule.

37. The apparatus according to claim 36, wherein said appearing rule takes account to any of a group comprising: a measured temperature, a date, a time, a user interaction, an incoming message, an incoming advertisement, a rendered media item, a position, connection to additional device, communication with certain entity, and an incoming phone call.

38. The apparatus according to claim 34, wherein said basic item is any of the group comprising an icon, a list item, an avatar, a virtual puppet, a menu item, a file item, a symbol, a help function item, a scroll bar, a selection bar, a selection frame, and a status message item.

39. The apparatus according to claim 34, wherein said accessing means is arranged to retrieve said additional items from a fashion indicator boutique.

40. The apparatus according to claim 39, wherein said accessing means comprises transaction means for securely accessing a web store of said fashion indicator boutique.

41. The apparatus according to claim 41, wherein said transaction means enable buying said additional item.

42. The apparatus according to claim 39, wherein said accessing means is arranged to retrieve said additional item as an advertisement from said fashion indicator boutique.

43. The apparatus according to claim 33, further comprising
input means arranged to receive user input;
an editor arranged to generate said fashion indicator upon and based on said user input.

44. The apparatus according to claim 43, wherein said user input comprises parameters for said visual effects.

45. The apparatus according to claim 33, further comprising a transmitter for transmitting said fashion indicator to another peer entity.

46. The apparatus according to claim 34, wherein said accessing means is arranged to retrieve said additional item by receiving said additional item from another peer entity.

47. The apparatus according to claim 34, wherein said additional item illustrates any of a group comprising: an article of clothing, accessories, jewellery, footwear, headgear, items of equipment, and sports goods.

48. The apparatus according to claim 33, belonging to a group comprising a mobile communication apparatus, a portable digital assistant, a portable media player, a digital camera, and a cell phone.

49. The apparatus according to claim 33, wherein said fashion indicator is a visual fragrance.

50. A computer-readable medium having computer-executable components comprising instructions for
providing a plurality of items on in a display view;
determining a theme comprising a fashion indicator; and
providing a visual effect associated with said fashion indicator in said display view.

51. The computer-readable medium according to claim 50, having computer-executable components comprising instructions for
retrieving an additional item comprising said fashion indicator; and
providing a visual effect wherein said additional item is fitted to at least one of said basic items in said display view.

52. The computer-readable medium according to claim 50, further having computer-executable components comprising instructions for providing one or more effect layers among said items when providing said visual effect.

53. The computer-readable medium according to claim 50, further having computer-executable components comprising instructions for making said visual effect appear according to a predetermined appearing rule.

54. The computer-readable medium according to claim 53, further having computer-executable components comprising instructions for applying said appearing rule upon an interrupt signal depending on a value of any of a group comprising: a measured temperature, a date, a time, a user interaction, an incoming message, an incoming advertisement, a rendered media item, a position, connection to additional device, communication with certain entity, and an incoming phone call.

55. A system comprising
an apparatus comprising a display arranged to display a display view with a plurality of displayed items; a theme receiver for receiving a theme comprising a fashion indicator; and a theme handler arranged to arrange said display view according to said theme, wherein the arrangement of said display view comprises provision of a visual effect illustrating said fashion indicator; and
a fashion indicator server arranged to provide a theme comprising a fashion indicator,
wherein said apparatus is arranged to receive said theme from said fashion indicator server.

56. The system according to claim 55, wherein said items are basic items, the apparatus further comprising an accessing means arranged to retrieve an additional item, wherein said additional item comprises a fashion indicator; and a processor for controlling said display and accessing means, wherein said theme handler is arranged to provide control such that said visual effect comprising said additional item fitted to at least one of said basic items in said display view.

57. The system according to claim 55, wherein said apparatus is arranged to buy said fashion indicator to access said fashion indicator from said fashion indicator server.

58. The system according to claim 55, wherein said fashion indicator server is arranged to provide said fashion indicator as an advertisement to said apparatus.

59. The system according to claim 55, wherein said system is a mobile communication system, and said apparatus is a mobile communication apparatus.
